(19) United States
(12) Patent Application Publication
(10) Pub. No.: US 2004/0260960 A1
(43) Pub. Date: Dec. 23, 2004

(54) Method for pulse train reduction of clocking power when switching between full clocking power and nap mode

(75) Inventors: Rolf Hilgendorf, Boeblingen (DE); Son Dao Trong, Stuttgart (DE); Stephen Douglas Weitzel, Round Rock, TX (US)

Correspondence Address: IBM CORPORATION (CS), C/O CARR LLP, 670 FOUNDERS SQUARE, 900 JACKSON STREET, DALLAS, TX, 75202, US

(73) Assignee: International Business Machines Corporation, Armonk, NY

(21) Appl. No.: 10/601,375

(22) Filed: Jun. 23, 2003

(51) Int. Cl. G06F 1/32; G06F 1/26

(52) U.S. Cl. 713/320

(57) ABSTRACT

The present invention provides for reducing power across the entirety of a processor in a series of incremental steps. The clocking power requirements of a processor are evaluated through a power analysis and pre-programmed into a power train generator. A state machine control ramp logic comprising pre-programmed states resets a delay counter and issues state instructions to a pulse train generator. A pulse train generator outputs constant pulse trains and variable pulse trains that mask the original clocking power frequency. The pulse trains are distributed through a timed clock control distribution network to local clock buffers. The conditioned pulse trains step up or step down the clocking power, to the entirety of the processor, resulting in a smoothing of the clocking power switching. The smoothing of the clocking power reduces electrical spikes, surges and capacitance within the processor.

### TECHNICAL FIELD

The present invention relates generally to the field of computer systems and, more particularly, to the reduction of clocking power consumption in a microprocessor.

### BACKGROUND

Power consumption is one of the biggest challenges in high performance microprocessor design. The rapid increase in the complexity and speed of each new generation of processors is outpacing the benefits of voltage reduction and feature size architecture. Designers are continuously challenged to come up with innovative ways to reduce power, while trying to meet all the other constraints of the overall design.

The push towards increasing levels of performance has required an increase in both frequencies and complexities. There are industry-wide concerns that power consumption may eventually set a finite limit on superscalar digital design.

There are two challenges for power reduction in high performance general purpose processors. First, the instruction-set and system architectures must be designed for a heterogeneous marketplace. This necessarily restricts the search applicable for low-power solutions. Second, it is necessary that the proposed solutions remain robust and scale gracefully across multiple technology generations. Finally, while significant power savings are required, they must be had at little or no loss of performance.

The operational costs of high frequency processors are not limited to fixed computing environments. Portable devices from laptops to DVD players are increasingly reliant on high demand processors, with a resultant power requirement. In practical applications, however, processors and associated co-processors and logic devices are seldom taxed by full clocking power demands.

Typically, the clock is the largest user of power within a processing unit. Conventional processor power saving technologies generally focus on reducing power to the clock using clock gating. Clock gating is a well-known technique to reduce clocking power. Because individual circuit usage varies within and across applications, not all the circuits are used all the time, giving rise to power reduction opportunities. By ANDing the clock with a gate-control signal, clock gating essentially disables the clock to a circuit whenever the circuit is not used, avoiding power dissipation due to unnecessary charging and discharging of the unused circuits. Specifically, clock gating targets the clock power consumed in pipeline latches and dynamic CMOS logic circuits that can be used for speed and area advantages over static logic.

Effective clock gating, however, requires a methodology that determines which circuits are gated, at what time, and for what duration. Clock gating schemes that either result in frequent toggling of the clock gated circuit between enabled and disabled states, or apply clock gating to such small blocks that the clock gating control circuitry is almost as large as the block itself, incur large overhead.

However, clock gating cannot be used indiscriminately. One large problem is that the disabled block may not power up in time, or that the modified clocks may generate mistimed signals known as skew. This requires strict timing constraints on the enabling signals plus a verification of the timing circuit. Skewing is the apparent or actual variance of the applied clock signal from the original reference clock. Generally, all processors contain at least one reference clock that is split into a plurality of slave clocks, driving other devices or systems. So, the granularity at which clock gating can be applied becomes a tradeoff against overall clock network design and complexity.

Another concern with clock gating is the impact on current variations when large blocks of logic are switched on and off. A processor may be at peak current levels for some cycles, when few sectors of the processor can be clock gated. However, a processor may rapidly transition to low values of power if a stall of the pipeline cache flush causes a large number of sectors to be powered off.

Furthermore, the scale of density continues to increase in processor design. This causes two additional problems. First are the additional power requirements for all the additional devices, and second is the extra heat generated. The added density and heat can cause degradation of the clock frequency and signal quality.

Thus, there is a need for a clock power reduction apparatus that overcomes at least some of the issues associated with conventional clock gating.

### SUMMARY OF THE INVENTION

The present invention provides for controlling a processor clock frequency in such a manner as to minimize processor power supply voltage variations while starting and stopping processor clock signals. In order to incrementally change the processor clocking frequency, a power interrupt signal activates a state machine ramp input signal to a state machine ramp control. A delay counter cycles the states and is reset. The state machine selects a pulse train from a generator. The generator multiplexes and masks the clocking power signal, fanning the signal through a timed clock control distribution network. The timed clock control distribution network drives the local clock buffers using the pulse trains. The local clock buffers substantially halt and then restart the processor.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a conventional system for reducing clock power;

FIG. 2 illustrates an apparatus for reduced clocking power with pulse trains;

FIG. 2A details a delay counter;

FIG. 3 is a diagram illustrating a process of state machine ramp controls;

FIG. 4 represents waveforms in power down mode; and

FIG. 5 represents waveforms in a power up mode.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

In the remainder of this description, a central processing unit (CPU) may be a sole processor of computations in a device. In such a situation, the CPU is typically referred to as an MPU (main processing unit). The processing unit may also be one of many processing units that share the computational load according to some methodology or algorithm developed for a given computational device. All processors process instructions under variable voltage conditions that range from full voltage at design architecture maximum to zero voltage, wherein the processor is processing no instructions. For the remainder of this description, all references to processors shall use the term processor whether the processor is the sole computational element in the device or whether the processor is sharing the computational element with other microprocessors, unless otherwise indicated.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

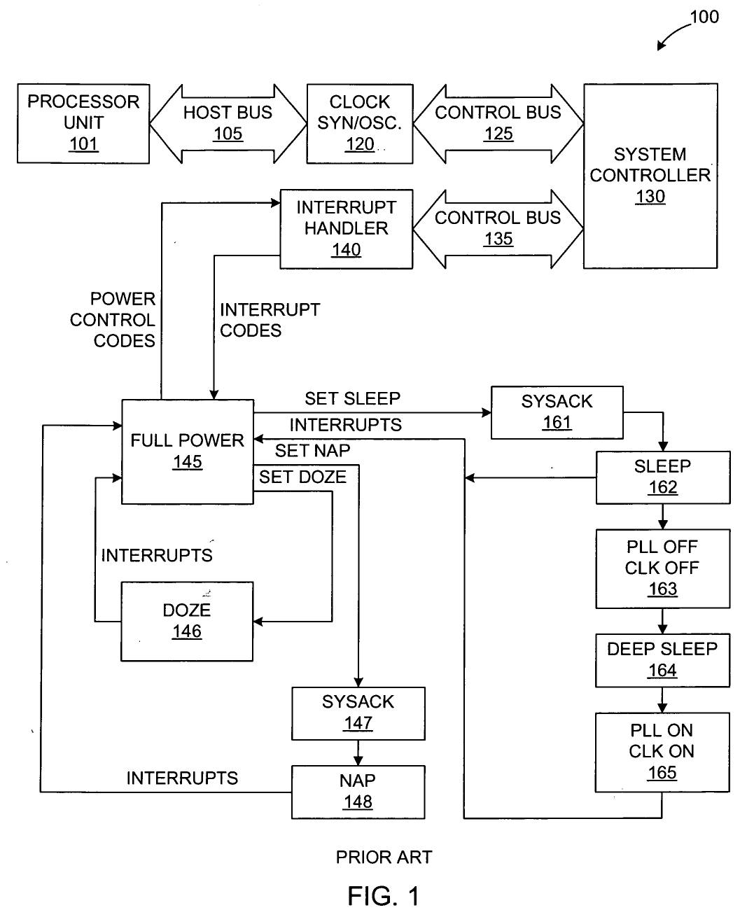

Turning to FIG. 1, disclosed is a conventional clocking power reduction system 100 having an interrupt handler 140. The interrupt handler 140 is the primary system for prioritizing and caching sent interrupt codes and received control codes. This prioritizing and caching cycle occurs in a full clocking power state or any one of a plurality of less than full clocking power states. The full clocking power or lack of full clocking power, however, does not directly affect the functioning of the cache. In a full clocking power state, all of the system designed power is delivered to the processor 101. In less than full state, less than full clocking power is delivered to the processor 101. It can be understood that FIG. 1 is only representative of clocking power control to a single processor. There can be a plurality of processors, each of which has a clock and attendant device.

Generally, interrupts are processing halts sent to either a software or a hardware device. In FIG. 1, interrupts are sent by the interrupt handler 140 to full power 145 (software or hardware). Dependent on the level of the interrupt signal (determined by a table hierarchy at the system controller 130), the full power 145 command is stopped. Typically, interrupts for less than full clocking power are determined by a system controller or other control device. Full clocking power is the maximum processor clocking defined by the system architecture. It can be the default power state, and is exemplified by the full power state 145.

The processor clocking power mode is derived from the system controller 130 specifications, the control bus 125 data bandwidth, and the processor design architecture parameters. The sum of these parameters is sent to the interrupt handler 140 from the system controller 130 and processed by computer code.

Full clocking power is one of the pluralities of options that can be asserted as an output utilizing full power device 145. The options are generally serial when acting on one processor. In an embodiment containing multiple processors, full clocking power or less-than-full-power can be asserted independently in parallel. Full power device 145 reasserts it is at full clocking power through a handshake or control signal that flows only in one direction from the interrupt handler 140 device towards the full clocking power device 145. However, the full power device 145 separately returns a control signal to the interrupt handler 140 to allow all interrupts to be in the default ‘off’ position (i.e. no interrupts are active for that portion of the power circuit).

In FIG. 1, those of ordinary skill in the art understand that a distinction is made between full clocking power, doze and nap states on one side of the clocking power cycle, and a diversity of sleep states on the other. The primary purpose of separating the circuit is to clearly define when the clock/oscillator 120 combination (which consists of two halves: the clock and the PLL) are affected (sleep states) or not affected (full clocking power and doze or nap states). The selection of the division is dependent on a plurality of processor architecture design elements. It can be modeled and coded in hardware or in software, and any number of reduced power states can be asserted. Generally, the clocking power devices are hardware devices.

Furthermore, those of ordinary skill in the art understand that the processor unit 101 can be logically and physically divided into segments or sectors for power control purpose. The segments or sectors at the processor 101 contain a plurality of gates, registers and other logic devices in hardware. It is these devices that are switched by interrupt codes. Interrupt codes tell systems, sub-systems and related devices to stop processing their instructions.

The five power states represented in FIG. 1 illustrate one possible design. The five representative power states are full power 145, doze 146, nap 148, sleep 162, and deep sleep 164. The purpose of segmenting the power states is a result of a logic decision to keep the phase lock loop (PLL) synthesizer (the clock), and the oscillator (the device that creates a digital frequency wave) at some combination of on or off. At full clocking power 145, doze 146 or at nap 148, the PLL and the clock remain on. At sleep 162, in the clock/oscillator device 120, the clock is off and the PLL is on. At deep sleep 164, both the clock and the PLL are off. A new interrupt from handler 140 is required at wake state 165 for the processor 101 to return to full clocking power.

The system acknowledgment 147 is typically a handshake device passing the interrupt code along the datapath. FIG. 1 shows the relative hierarchy of the various states. Full power 145 typically occurs before nap 148 which, in turn, typically occurs before deep sleep 164. The power adjustment can last one clock cycle or more. In other words, the interrupt handler 140 cycles through these various software states after sending a request to the full power 145, reads back the parameters, and applies the parameters to the processor unit 101.

The processor unit 101 is coupled to the clock and synthesizer 120 via a host bus 105. The host bus 105 is a conduit and termination point for signals passing between the clock 120 and the processor 101. A control bus 125 and a control bus 135 operate similarly.

Full power 145 always returns at least one control value to the interrupt handler 140. The architecture of the interrupt handler stops the interrupts from turning on (which would indicate a less than full clocking power demand on the clock). The interrupt handler 140 executes and passes a signal through the control bus 135 to the system controller 130. This signal is proceeding uninterrupted through the system until it arrives at the processor 101, where the processor logic understands that all devices have authority to operate at full design capability. The full clocking power state is statically designed, as are any other intermediate states. In other words, there is only one full clocking power state, there is only one doze state, et cetera. The power states are considered switches, switching only on or off. While full power 145, for example, can issue a control signal, it is not, in itself, a controller. Controller functions are exclusive the system controller 130 in this section of the system 100.

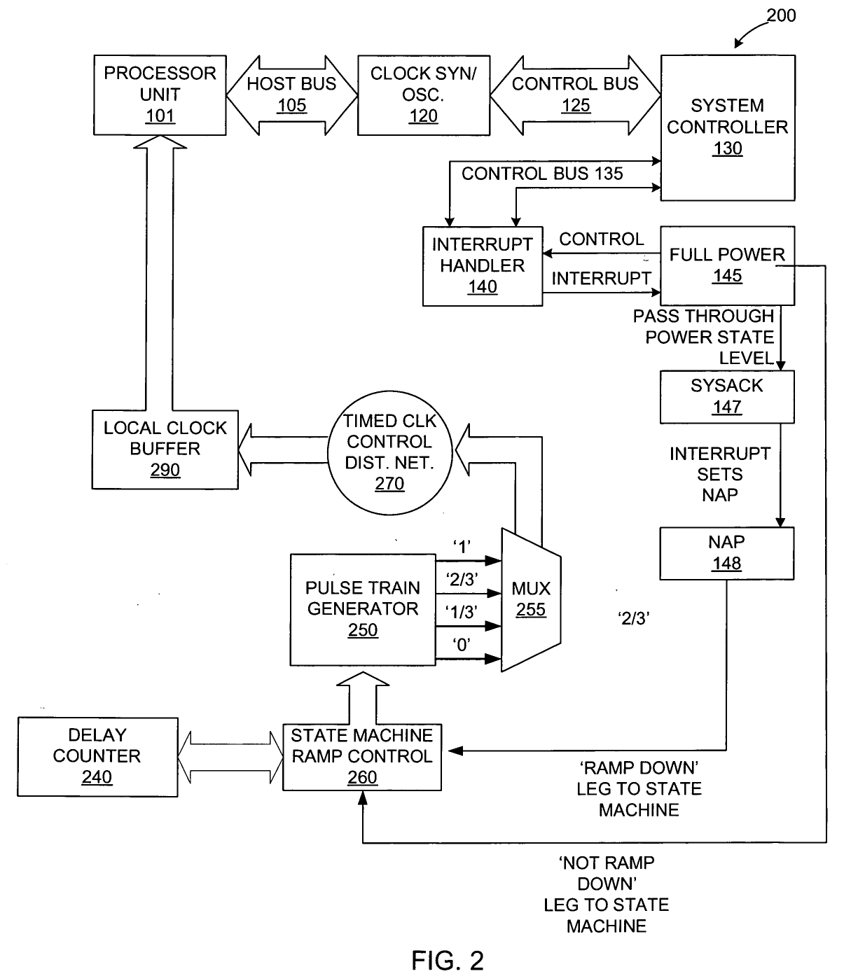

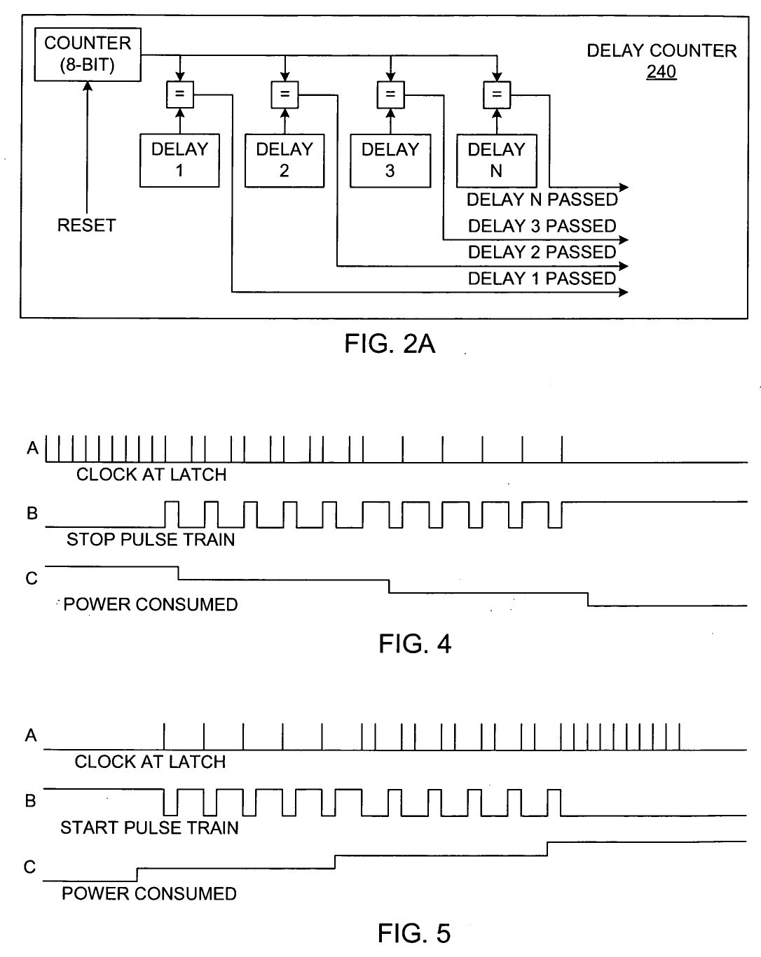

Turning now to FIG. 2, disclosed is a clocking power reduction system 200 with a pulse train generator (PTG) 250. The system 200 is exemplary of one design of a plurality of reduced power state pathways and configurations possible. Typically, the pathways comprise hardware devices that induce a state of reduced processor operation by a device such as nap 148 (which is invoked to turn off one or more sectors at the processor). These devices are affixed in close proximity to the processor 101 because they need to turn on and off sectors of the processor quickly and precisely. The system 200 can be remote of the processor except for the pathway from the local clock buffer 290.

The timed clock control distribution network 270 (TCCDN) receives train pulses via a multiplexer 255 (MUX). The MUX 255 mixes and aligns the pulse trains from the PTG 250. The purpose of the TCCDN 270 is to fan-out the pulse trains to the local clock buffers 290, delivering the pulse trains at precisely the same moment to each individual LCB 290. Without this distribution network 270, the clocking signal and the pulse trains arrive out of sequence and at random, corrupting the processor data in processor 101.

Typically, the primary processor clock 120 is divided into a plurality of clocking power outputs, driving a multitude of devices. The outputs can be turned off severally or jointly by a plurality of hardware interrupts. It is generally understood by those of skill in the art that the system 200 represented here can contain a plurality of parallel circuits driven by these clocking power outputs, and acted on dependently by the clocking power output of clock 120.

In a latching system, all clocks drive a variety of processes, such as registers, counters and latches. A timing mechanism launches via the host bus 105 and control bus 125. The logical value stored within the latches varies from a high state to a low state, a logical ‘1’ or a logical ‘0’. The number of devices operating is dependent on the number of the latches clocking on or off within the processor 101 and the frequency of the signal delivered through the LCB 290, originating with clock 120. Additional embodiments of the invention can include a plurality of processors and their attendant clocks, in series or in parallel. The circuits thus described can contain a plurality of less-than-full-power states.

Initialization of the ‘go to nap’ command is via an instruction from the processor 101. Through the chain of attached buses and devices, the full power 145 sends a request to the nap 148 through an interrupt issued at interrupt handler 140. Immediately, full power 145 simultaneously issues a control acknowledgment to the interrupt handler 140, a ramp down request to one input of the state machine ramp control (SMRC) 260 and sets the nap 148 device. Concurrently, a control signal returns from full power 145 through the buses and devices, ending at the processor 101, which removes the interrupt request. Full power 145 is then set at idle, waiting for a new interrupt instruction from processor 101.

The ‘ramp down request’ interrupts pass to the state machine ramp control (SMRC) 260. The function of the SMRC 260 is to cycle and reset delay counter 240.

Turning briefly to FIG. 2A, disclosed is an 8-bit delay counter 240. The delay counter 240 consists of a plurality of delays that can be infinite in number. The delay counter contains a programmable logic device for partitioning and sequencing the initial delay and every subsequent delay, based on the passing (logical AND gate) of each preceding delay. Typically, the counter is in reset mode, which is a logical ‘0’ or null mode. To start the counter, the SMRC 260 releases the reset signal that the SMRC 260 held at idle. The counter increments by a value of 1 after each clock cycle. In each 8-bit latch delay is a pre-programmed value derived from the external power analysis of the processor architecture. When the delay counter 240 has reached a value that is one of the values stored in one of the delays (for example, delay 1 or delay 2), the corresponding signal “delay ‘x’ passed” is asserted. The counter continues to count clock cycles until reset is reasserted from the SMRC 260.

There is a plurality of delay states possible in the delay counter 240. These are design elements that describe time increments (by clock cycles or other timing means) from delay 1 to delay 2, from delay 2 to delay 3, and from delay 3 to delay (n) in an infinite number of iterations. Included are delays between the ramp down requests and delays between states (1) through state (n) that are the delay states in the delay counter 240. There is also a delay between delays (n) passed and delays (n) not passed, with the same infinite timing scheme as for the delay counter 240. The length of time for the delay can be coded in software or by means of hardware devices.

Turning again to FIG. 2, disclosed is the output of PTG 250, which has four discrete states “0”, “⅓”, “⅔” and “1”. These numbers represent different pulse trains. The four power states are only illustrative of one embodiment of the apparatus. There can be any number of pre-programmed pulse trains within the PTG 250 control logic and any number of states from SMRC 260 used to select the discrete pulsed outputs. The pulses thus generated are routed to the timed control distribution network 270 (TCCDN). The TCCDN 270 fans out (i.e., routes the pulse train) to the local clock buffers 290. The logic of the TCCDN 270 is that of a simple ORed gate.

Each of the local clock buffers (LCBs) 290 matches to a clocking power entry node (i.e., logic contact points) in the die at processor 101. Local clock buffers can also reside at any other point utilizing a clock frequency. LCBs are clocking power conditioning devices for duplication, distribution and fan-out of the clock signal and pulse trains. There can be a plurality of LCBs matched to a plurality of processors with one or more pulse trains driving them in series or in parallel. Those versed in the art understand that these devices may be on the same chip or on the same circuit board or on a plurality of circuit boards and chips, and all logically connected.

The LCB 290 distributes the signals according to the netlists contained within a memory logic device. Netlists are lists or tables of conditions matched to actions, residing in programmable storage in the processor 101.

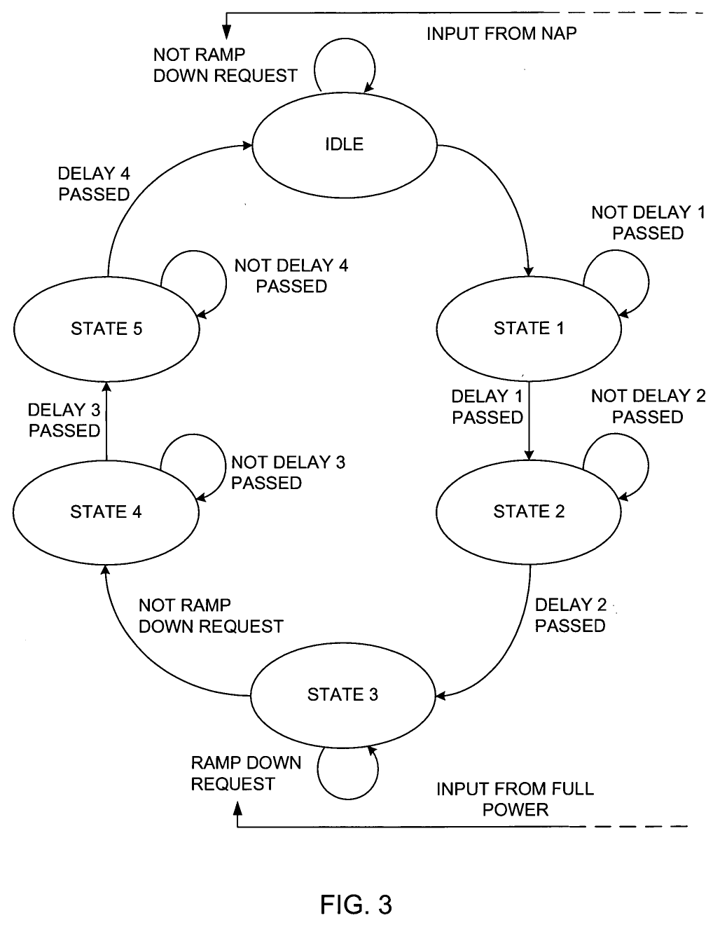

Turning to FIG. 3, disclosed is one embodiment of the state machine delay and pass logic sub-system that drives the delay counter 240 devices and issues the state select signal to the PTG 250.

Delay (n) represents the discrete difference of the clock 120 periodicity pre-programmed from the processor 101 clocking power analyses. The counter counts delay (1) at state (1) and waits for delay (2). Delay (2) arrives and is counted by the counter, advances state (1) to state (2), until state (n) is passed and the SMRC returns to idle, as the result of a ‘not ramp down request’.

At idle, the state machine is in null mode and this state signals the PTG 250 to oscillate constant low waveform ‘0’, which produces a constant clock power of the highest design frequency. As ramp down requests are received, the state machine logic transitions from state to state selecting the pulse trains that are pre-programmed. Generally, the delay counter is asserting or deasserting reset and the pulse train select is changing from ‘1 cycle high 2 cycle low’ to ‘1 cycle low 2 cycle high’. At a selection of ‘1’, the clocking power is essentially stopped, though there is always a low level clocking power to maintain vital processor function, even in the deepest sleep mode.

If “delay 2 passed” is simultaneously asserted at a first ramp down request, the SMRC 260 transitions into state 3. The delay is a time function programmed into the state machine logic, waiting a specified number of clock cycles, before passing into the next state.

Within each delay state is a sub-state timing delay that is calculated from the algorithms in the delay counter. These sub-state delays are an intermediate and determinate, time dependent idle to the various states (except for the idle state that is actually a null position with no active state). This means that in each overall state, as in “state 1,” there is a sub-state ‘n’ that functions as a timer until the logic determines that state 1 should pass to state 2 or be rescinded (reset).

If there is no delay from the delay counter 240 in FIG. 2, the state remains static. That is, no delay is asserted and no pass is asserted; in other words, a null state devoid of active processing. However, as the final delay in the delay cascade is passed through the delay counter 240, the logic in the SMRC 260 algorithm forwards the request to the PTG 250, where the correct pulse train to power the processor 101 is selected.

The pulse train select at generator 250 issues a pulse train when the SMRC 260 has made a selection from a comparison of the passed delays waiting at the delay cache 245 to a constant ‘high’ pulse train. The constant high pulse train always indicates an effective clocking power stop condition. The constant low pulse train always indicates a ‘full clocking power’ to processor 101 condition.

At any point between constant ‘high’ and constant ‘low’, the PTG 250 can use control logic to select one of the pulse trains. Matching the pulse train at a defined point is required to initiate the smooth transition of changed power states in the processor 101. This step is a significant advancement over the prior art, where the power changes are simply on-off without a transitional phase. As is understood by those of skill in the art, all of the units thus described may reside on a single integrated circuit chip or on discrete circuit boards, and can embody design elements through hardware or software.

Referring briefly now to FIG. 4, disclosed is an exemplary display of waveforms indicating that the processor is powering down, smoothly. Waveform ‘A’ indicates a clock at latch, where latch is the logic state flip-flop equivalent of an ‘on-off’, clock cycle. Waveform ‘B’ displays the masking pulse train multiplexed from the PTG 250, wherein it is seen that the pulses are decrementing at the same time as the clock at latch. Waveform ‘C’ illustrates the smooth reduction in power (i.e., decrease in watts) that is novel in the system 200.

Referring briefly now to FIG. 5, disclosed is an exemplary display of waveforms indicating the processor is powering up smoothly from an effectively stopped state. Waveform ‘A’ displays a clock in the process of shifting from the reduced power state and latching additional gates at the processor (i.e., indicating higher frequency required to process instructions). Waveform ‘B’ displays the change in the pulse train that matches the higher frequency. Waveform ‘C’ displays the smooth transition to the full clocking power state that is a feature of the system 200 in FIG. 2.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A microprocessor control apparatus for uniformly reducing processor power independent of the processor logic, comprising:
a full power state machine control input;
a nap state machine control input;
a state machine ramp control;
a delay counter;
a pulse train generator;
a multiplexer;
a timed clock distribution control network;
a local clock buffer;
a full power state machine control input controlling the ‘ramp down’ request;
a nap state machine control input controlling the ‘not ramp down’ request input;
a full power state machine control input and a nap state machine control input coupled to a state machine ramp control;
a state machine ramp control connected to a delay counter and coupled to a pulse train generator;
a pulse train generator supplying and mixing pulses through a multiplexer connected to a timed clock control distribution network; and
a timed clock control distribution network coupled to a local clock buffer.

2. The system of claim 1, wherein the nap interrupt device is coupled to the state machine ramp control through the ramp down request module.

3. The system of claim 1, where a pulse train generator further comprises a delay counter unit and a state machine ramp control unit, wherein the pulse train generator is employed to transmit the pulse train to the timed clock control signal distribution network.

4. The system of claim 1, further comprising a local clock buffer control device employed to exercise control of the processor by means of conditioning the clock signal.

5. The system of claim 1, wherein the pulse trains from the pulse train generator drive the local clock buffer devices.

6. The system of claim 1, further comprising an external power analysis, wherein processor clocking power is analyzed for power requirements for all processor processes.

7. The system of claim 3, wherein the ramp down request device includes a signal device between the processor and the state machine ramp control to transmit the ‘go to nap’ command.

8. The system of claim 3, wherein the counter to create delay for next step unit includes an input/output loop to transmit signals to the state machine control ramp during a time period when the ramp down request is active.

9. The system of claim 4, wherein a local clock buffer device conditions a latch at a processor node.

10. The system of claim 3, wherein one or more devices can include a programmable memory storage device or input device.

11. A method for performing a plurality of shifts in clock frequency, comprising:
initiating a ramp down request as a function of a change in a power interrupt request;
incrementing a counter to start a state machine ramp control;
initiating a state machine ramp control logic;
selecting a pulse train from a pulse train generator;
masking a clocking power signal;
fanning out a pulse train;
driving a pulse train to the local clock buffers;
substantially halting a processor with a constant low signal; and
substantially restarting a processor at full power with a constant high signal.

12. The method of claim 11, wherein a pulse train is selected by a specific state within a state machine control ramp.

13. The method of claim 11, wherein a selected pulse train is multiplexing and masking a clocking power signal.

14. The method of claim 11, wherein a timed clock control distribution network is fanning out a pulse train.

15. The method of claim 11, wherein the multiplexed pulse train is driving local clock buffers.

16. The method of claim 11, wherein the local clock buffer is conditioning the pulse trains arriving through the timed clock control distribution network.

17. The method of claim 11, wherein the conditioned pulse train is latching processor gates.

18. The method of claim 11, wherein a zero pulse train effectively halts processor operation.

19. The method of claim 11, wherein a one pulse train is effectively sending full clocking power to the processor.

20. A computer program product for authenticating code in a computer system, the computer program product having a medium with a computer program embodied thereon, the computer program comprising:
computer code for accepting ‘not ramp down’ requests from less than full power modes;
computer code for accepting ‘ramp down’ requests from full power modes;
computer code for initiating a ramp down request as a function of a change in power interrupt request;
computer code for incrementing a counter to create a delay for initiating a state machine ramp control for a pulse train;
computer code for initiating a ‘pass’ or ‘not passed’ delay between state machine ramp control states;
computer code for selecting the appropriate pulse train; and
computer code for sending the selected pulse train to the local clock buffers.

21. A computer program for providing clocking power control in a computer system, the processor including a computer program comprising:
computer code for accepting ‘not ramp down’ requests from less than full power modes;
computer code for accepting ‘ramp down’ requests from full power modes;
computer code for initiating a ramp down request as a function of a change in power interrupt request;
computer code for incrementing a counter to create a delay for initiating a state machine ramp control for a pulse train;
computer code for initiating a ‘pass’ or ‘not passed’ delay between state machine ramp control states;
computer code for selecting the appropriate pulse train; and
computer code for sending the selected pulse train to the local clock buffers.
